(19) United States
(12) Patent Application Publication
(10) Pub. No.: US 2011/0283654 A1
(43) Pub. Date: Nov. 24, 2011

(54) Mounting rail

(75) Inventors: Frederic Pol, Feldkirch (AT); Markus Heudorfer, Buchs (CH); Ulrich Birnbaum, Epfenhausen (DE); Denis Novokshanov, Buchs (CH); Holger Basche, Meiningen (AT)

(73) Assignee: Hilti Aktiengesellschaft, Schaan (LI)

(21) Appl. No.: 13/068,804

(22) Filed: May 20, 2011

(30) Foreign Application Priority Data
May 21, 2010 (DE) 10 2010 029 213.3

(51) Int. Cl. E04B 1/38; B23P 17/00

(52) U.S. Cl. 52/710; 52/742.15; 29/458

(57) ABSTRACT

In the case of a mounting rail (1) for embedding into a curable construction material (3), e.g. concrete (4), with a support profile (2), with at least one opening (14) made in the mounting rail (1), especially in the support profile (2), and with an anti-corrosion coating (7) created on the surface of the mounting rail (1), an adequate corrosion protection of the mounting rail (1) should exist in the area of the openings (14), even when the mounting rail (1) is hot-galvanized before the openings (14) for nails (16) or screws are created in the mounting rail (1). A plug is inserted into the at least one opening (14), so that the at least one opening (14) is closed by the plug.

This claims the benefit of German Patent Application No. 10 2010 029 213.3, filed May 21, 2010 and hereby incorporated by reference herein.

The present invention relates to a mounting rail, to a method for embedding a mounting rail, to a method for the production of a mounting rail and to a structure.

### BACKGROUND

In construction technology, anchor rails or mounting rails are poured or embedded into concrete so that only the top or an outer area of a support profile of the mounting rail is freely accessible. The mounting rail transmits the forces that are applied to it into the concrete through contact or through a connection at an embedding area in the surrounding concrete. In this case, the mounting rail has anchors that are generally on the back. In general, active forces are introduced into the concrete essentially by the support profile and by the anchors.

Before the concrete is installed, the anchor rail is fastened in a space surrounded by formwork, after which the concrete is installed, so that the anchor rail is connected to the concrete at an embedding area. Here, it is necessary for the anchor rail to be fastened to a fixation object, especially to the formwork. For this purpose, the mounting rail has several openings and it is fastened to the formwork by means of fastening means such as, for example, a nail or a screw. Generally speaking, the openings in the mounting rail are made by punching or drilling. In this process, at least two openings are generally needed on a mounting rail or on a section of the mounting rail so that the mounting rail can be fastened to the fixation object with nails or screws. In actual practice, a large number of openings is made in a mounting rail or in a section of the mounting rail in order to permit an adequate fixation of the mounting rail. As a rule, not all of this larger number of openings receive a nail or screw, so that, for example, of five openings in a mounting rail, only two or three openings receive a nail. The mounting rail encloses an interior space. This interior space contains a filler, e.g. foam, in order to prevent the construction material, e.g. laitance, from penetrating into the interior space. If the foam does not ensure an optimal seal, then concrete or laitance can penetrate into the interior space through the remaining openings that do not have fastening means in them.

In order to prevent corrosion of the mounting rail, an anti-corrosion coating often is applied onto its surface, for example, zinc plating. When the mounting rail is produced, it is first provided with the anti-corrosion coating, for example, it is hot-galvanized, and subsequently the openings are made in the mounting rail, for example, by punching or drilling. As a result, new surfaces in the form of a delineation rim along the opening are created on the mounting rail at the openings. There is no anti-corrosion coating on this delineation rim, so that, in this area, there is a risk of corrosion of the mounting rail.

During the production of the mounting rail, the application of the anti-corrosion coating, for example, in the form of a batch galvanization or a hot-galvanization, can only be carried out after the openings have been made. This, however, involves considerable drawbacks from the standpoint of production technology. The variability and flexibility of the time sequences of the production process are limited, and moreover, this entails higher manufacturing costs.

German patent application DE 101 25 970 A discloses a mounting rail having two half guideways running in the lengthwise direction that are joined to each other. The half guideways are joined together by means of connectors, whereby the connectors are preferably configured as clamp connectors. The mounting rail is intended for embedding into concrete in a floor or wall of a building, and the mounting rail is filled with a filler in order to prevent the concrete from penetrating into the mounting rail.

### SUMMARY OF THE INVENTION

It is an object of the present invention to provide a mounting rail, a method for embedding a mounting rail, a method for producing a mounting rail, and a structure with which an adequate corrosion protection of the mounting rail exists in the area of the openings, even when the mounting rail is hot-galvanized before the openings for nails or screws are created in the mounting rail.

The present invention provides a mounting rail for embedding into a curable construction material, e.g. concrete, with a support profile, with at least one opening made in the mounting rail, especially into the support profile, and with an anti-corrosion coating created on the surface of the mounting rail, whereby a plug is inserted into the at least one opening, so that the at least one opening is closed by the plug.

Since there is a plug in the at least one opening, that is to say, in each case, one plug is inserted into the at least one opening, no concrete or laitance can penetrate into the interior space of the mounting rail that is surrounded by the formwork after the concrete has been installed. Moreover, the plug can also prevent corrosion of a delineation rim of the opening.

In particular, the plug is connected to the mounting rail positively and/or non-positively.

In another embodiment, the plug is clamped into the mounting rail.

In a supplementary embodiment, the height of the plug corresponds essentially to the length of the at least one opening and/or the at least one opening is completely closed by the plug and/or the plug is provided with anti-corrosion coating on the outside. This means that the height of the plug can amount to at least 98%, 95%, 90%, 80%, 70% or 60% of the length of the at least one opening and/or corresponds to the thickness of the mounting rail in the area of the at least one opening. An outside area of the plug is preferably an area where the plug is in contact with the surroundings of the mounting rail and/or is not in contact with the mounting rail, especially with the delineation rim of the mounting rail.

Preferably, the plug can be removed from the at least one opening by means of a force being applied onto the plug, and/or the anti-corrosion coating is a zinc coating.

In an additional embodiment, a plug is inserted into all of the openings of the mounting rail. Therefore, the plug can be removed from the opening by applying a force onto the plug, and subsequently a fastener or fastening means, for example, a nail, can be inserted into the opening and, as a result, the mounting rail can be fastened to a fixation object, for example, the formwork.

In one variant, the cross section of the support profile is essentially C-shaped and/or the mounting rail is configured with at least one means for fastening at least one add-on part onto the mounting rail, and preferably the means for fastening add-on parts comprises at least one bolt and/or at least one screw, for example, a T-head bolt, a groove, a slit or the interior space enclosed by the support profile and having a lengthwise opening in the form of a groove or a slit.

Advantageously, the mounting rail has at least one, preferably several, anchors for embedding into the curable construction material and preferably the at least one anchor is fastened to the support profile.

In another embodiment, the mounting rail, especially the support profile, consists at least partially, especially entirely, of metal, for instance, iron, steel or aluminum, and/or the mounting rail is produced by means of a method described herein.

A method according to the invention for embedding a mounting rail, especially a mounting rail described in this patent application, into a curable construction material, for example, concrete or mortar, comprising the following steps: arranging the mounting rail with its support profile at the place where it is to be embedded, installing a curable construction material into a space delineated by formwork so that the support profile is connected to the curable construction material at an embedding area, curing the construction material, affixing the mounting rail before installation of the curable construction material in that, in each case, one fastening means is inserted into at least one opening in the mounting rail, and the fastening means is connected to a fixation object, especially to the formwork or a support, whereby before the fastening means is inserted into the at least one opening, a plug inserted into the at least one opening is removed from the at least one opening.

In particular, the plug is removed from the at least one opening in that a compressive force is applied onto the plug by the fastening means, so that the plug is pushed out of the at least one opening, and subsequently the fastening means is pushed into the at least one opening. At first, the plug is inserted into the at least one opening, especially in all of the openings of the mounting rail. As a result, in an advantageous manner, after the concrete has been installed, no construction material, especially no laitance, can penetrate into the interior space of the mounting rail. Only the openings that are needed for fastening the mounting rail are activated in that the plug is removed from the opening, as a result of which the fastening means can be inserted into the opening.

In another embodiment, a nail, a screw or a bolt is inserted as the fastening means into the at least one opening.

A method according to the invention for the production of a mounting rail, especially a mounting rail described in this patent application, comprising the following steps: providing a mounting rail that has a support profile, coating the mounting rail with an anti-corrosion coating, making at least one opening into the mounting rail, especially into the support profile, after the mounting rail has been coated with the anti-corrosion coating, whereby after the at least one opening has been made, a plug is inserted into the at least one opening.

In another variant, the at least one opening is made by punching and, after a slug has been punched out, the slug is inserted as the plug into the at least one opening.

In another embodiment, the top and/or the bottom of the slug is provided with the anti-corrosion coating, so that, during the punching and/or during the insertion, part of the anti-corrosion coating is applied onto the top and/or bottom of the slug on a delineation rim of the mounting rail at the at least one opening. As a result, in an advantageous manner, the delineation rim of the mounting rail also has an anti-corrosion coating at the at least one opening, so that, even if the mounting rail is coated with the anti-corrosion coating before the at least one opening is made in the mounting rail, the mounting rail has an anti-corrosion coating, especially a zinc coating, in the area of the at least one opening.

In an additional embodiment, the anti-corrosion coating is applied by hot-galvanization.

In a supplementary embodiment, the anti-corrosion coating is applied by zinc-plating by means of pre-galvanization, for example, as HDG+ galvanizing or as continuous-strip galvanizing.

A structure or component of the structure according to the invention, e.g. a wall or floor, made of a curable construction material and having a mounting rail embedded into the construction material, whereby the mounting rail is configured as a mounting rail described in this patent application and/or the structure or the component of the structure is produced with a method described in this patent application.

### DETAILED DESCRIPTION OF THE DRAWINGS

Below, an embodiment of the invention is described in greater detail, making reference to the accompanying drawings. The following is shown:

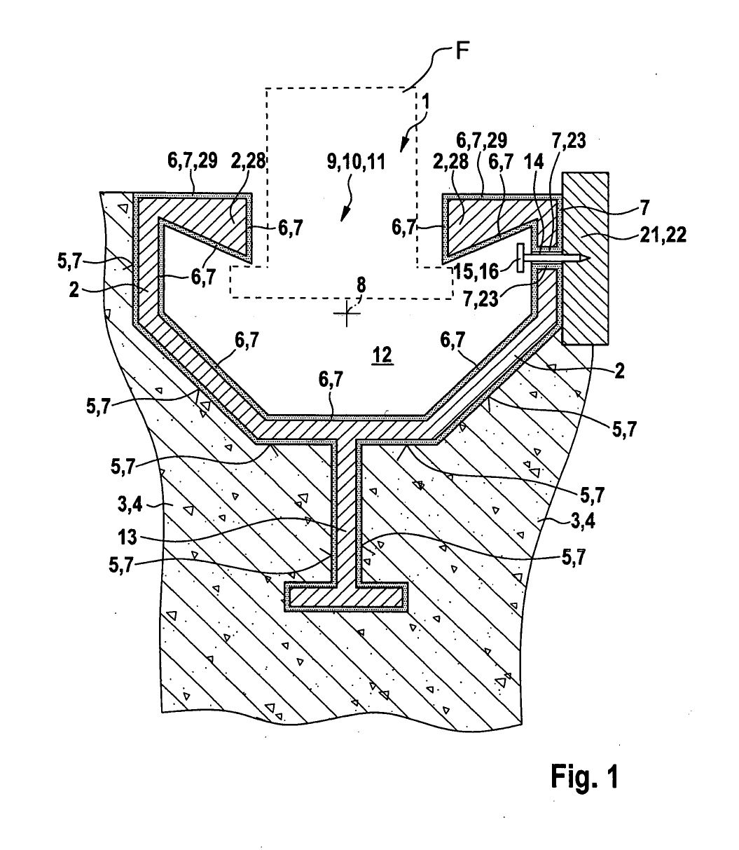

FIG. 1 a cross section of a mounting rail embedded into concrete,

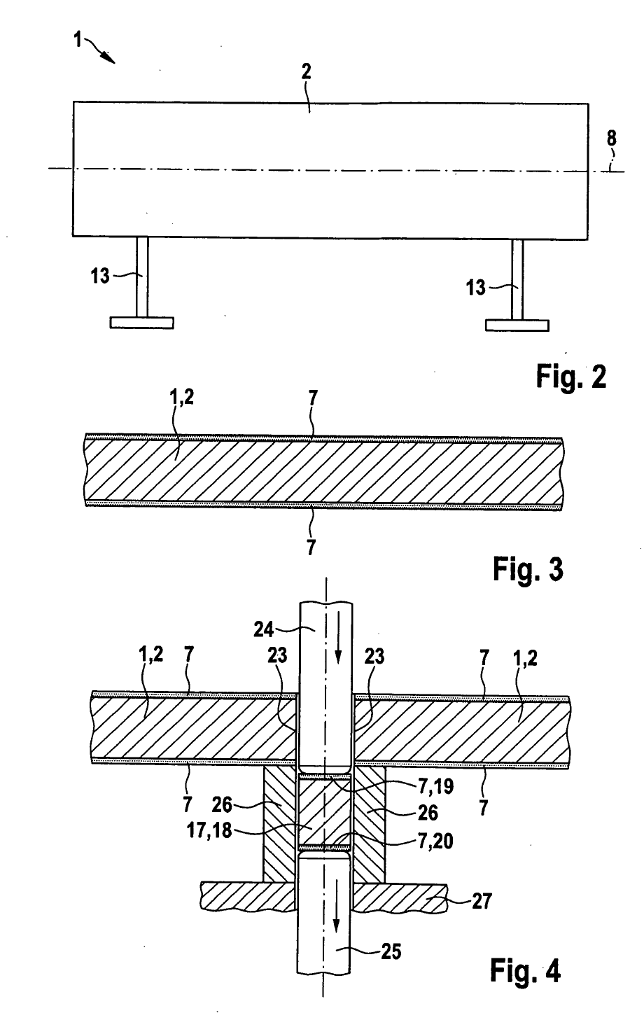

FIG. 2 a side view of the mounting rail according to FIG. 1,

FIG. 3 a partial cross section of the mounting rail before an opening is punched in the mounting rail,

FIG. 4 a partial cross section of the mounting rail after a slug is punched out of an opening in the mounting rail,

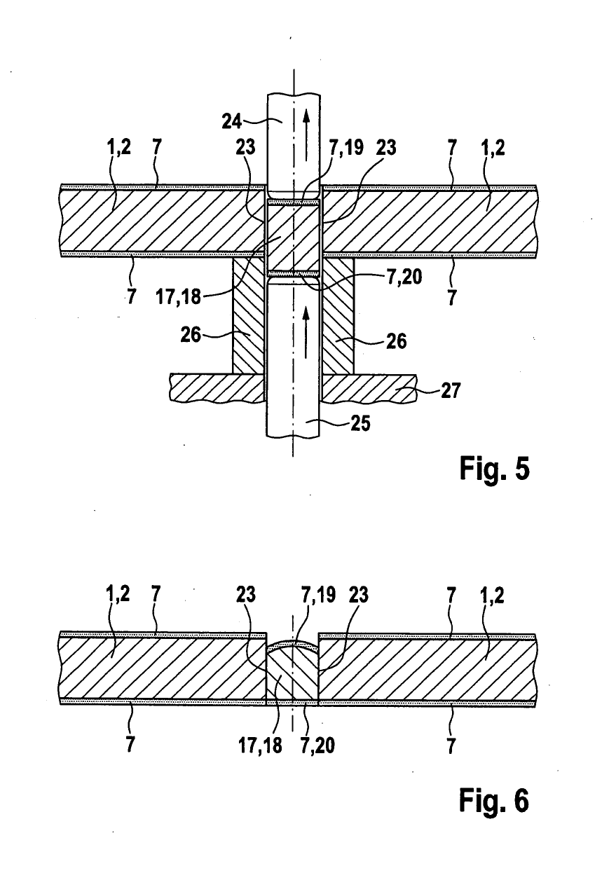

FIG. 5 a partial cross section of the mounting rail while the slug is being pushed back into the opening of the mounting rail, and

FIG. 6 a partial cross section of the mounting rail with the slug pushed back into the opening.

### DETAILED DESCRIPTION

FIGS. 1 and 2 show a mounting rail 1 or anchor rail 1 without filler material. The mounting rail 1 having a longitudinal axis 8 consists of a support profile 2 made of metal, especially steel or aluminum. An anchor 13 is fastened to a lower leg of the support profile 2 oriented horizontally in FIG. 1. In addition to the horizontally oriented legs of the support profile 2 described above, the support profile 2 also has two vertically and obliquely oriented legs. At the upper end of the vertically oriented leg of the support profile 2, there are two horizontally oriented strip legs 28. The strip legs 17 of the support profile 2 have an undercut on the bottom. On the outside, at an embedding area 5, the lower, essentially horizontally oriented leg and the two vertically and obliquely oriented legs of the support profile 2 are in direct contact with concrete 4 as the curable construction material 3, e.g. the wall of a structure. Consequently, these legs create the embedding area 5 of the support profile 2 on the outside. The two strip legs 28 are not in contact with the concrete 5 at one upper edge of the leg 29, i.e. they form an outer area 6 of the support profile 2. Moreover, the outer area 6 is formed by the other legs of the support profile 2 on an interior space 12. The support profile 2 encloses the interior space 12. The interior space 12 has a lengthwise opening 11 in the form of a slit 9 or a groove 10. A means for fastening add-on parts F, shown schematically in FIG. 1, such as a T-head screw or T-head bolt, can be fastened in the interior space 12. As a result, it is possible for the mounting rail 1 to withstand a load. The anchors 13 are likewise embedded into the concrete 4 and they ensure that the mounting rail 1 can withstand correspondingly large forces or loads.

The entire surface area of the mounting rail 1 is provided with an anti-corrosion coating 7. In this context, the anti-corrosion coating 7 is a zinc coating. As an alternative, the anti-corrosion coating 7 can also consist of or include other organic and/or inorganic anti-corrosion materials. Several openings 14 are made in the mounting rail 1. The mounting rail 1 is fastened to formwork 22 as the fixation object 21 by means of openings 14 and by fasteners or fastening means such as nails 16 inserted into each opening (FIG. 1). The mounting rail 1 has several openings 14 by means of which the mounting rail 1 is fastened to the formwork 22. The sectional view in FIG. 1, however, only shows one opening 14. The opening 14 is delineated by a delineation rim 23 of the mounting rail 1. Here, the mounting rail 1 also has the anti-corrosion coating on the delineation rim 23. As a result, complete anti-corrosion protection of the mounting rail 1 is possible, also in the area of the openings 14.

FIGS. 3 and 6 show the production process for making the openings 14 as well as the subsequent insertion of a plug 17 as the slug 18 into the opening 14. FIG. 3 shows a partial cross section of the mounting rail 1 before the opening 14 has been made. The entire surface area of the mounting rail 1 is provided with an anti-corrosion coating 7 in the form of a zinc coating. Before the openings 14 are made in the mounting rail 1, the anti-corrosion coating 7 is applied to the mounting rail 1 by pre-galvanization, for example, as HDG+galvanizing or continuous-strip galvanizing. As a result, the entire raw material of the mounting rail 1 is galvanized before the subsequent processing. Subsequently, a punching tool 24 (FIG. 4) punches the opening 14 into the mounting rail 1. The opening 14 can have any desired cross sectional shape and it can be configured to be, for instance, circular, square, rectangular or polygonal. The punching tool 24 punches out part of the mounting rail 1 which, after the punching procedure, is held by a guide part 26 as the plug 18. The guide part 26 rests on a support 27 (FIGS. 4 and 5). After the punching tool 24 has punched the opening 14 (FIG. 4), the opening 14 is delineated by a delineation rim 23 of the mounting rail 1. The plug 18 has a top 19 and a bottom 20. The plug 18 also has the anti-corrosion coating 7 on the top and bottom 19, 20. After the plug 18 has been punched out, the plug 18 is pushed back into the opening 14 by means of a pressing tool 25 (FIG. 5). In the final state shown in FIG. 6 without the punching tool 24 and the pressing tool 25, the slug 18 once again completely closes the cross section of the punched opening 14.

While the slug 18 is being punched by means of the punching tool 24 and while the slug 18 is being pushed back into the opening 14 by means of the pressing tool 25, part of the anti-corrosion coating 7 that is present on the top and bottom 19, 20 accumulates on the delineation rim 23 of the mounting rail 1 at the opening 14. As a result, in the final state shown in FIG. 6, an anti-corrosion coating 7 is also present on the delineation rim 23. This anti-corrosion coating 7 on the delineation rim 23 can be thinner than the coating 7 on the outer surfaces and is not shown thickly in FIG. 6. The slug 18 is also shown schematically in FIG. 6, depending on the punching process can have been slightly deformed by the process, although this deformation is not shown in FIGS. 4 and 5.

The slug 18 shown in FIG. 6 and arranged in the opening 14 can easily be removed at the construction site with a fastening means 15, for example, the nail 16. For this purpose, the nail 16 merely has to be used to apply a compressive force onto the slug 18 that is clamped in the opening 14, so that this pushes the slug 18 out of the opening 14 and subsequently, the nail 16 can be fastened, for instance, in the formwork 23 (FIG. 1).

All in all, major advantages are associated with the mounting rail 1 according to the invention. Before the openings 14 are made in the mounting rail 1, the mounting rail 1 can be provided with the anti-corrosion coating 7, thereby considerably simplifying the production of the mounting rail 1. The openings 14 are closed by the slug so that openings 14 that are not needed to fasten the mounting rail 1 to the formwork 22 do not allow concrete or laitance to penetrate through these openings 14 into the interior space 12. Moreover, the delineation rim 23 of the mounting rail 1 also has an anti-corrosion coating, so as to ensure that, in this area of the mounting rail 1 as well, the mounting rail 1 has adequate anti-corrosion protection.

What is claimed is:

1. A mounting rail for embedding into a curable construction material, comprising:
a support profile, at least one opening being formed in the support profile or another part of the mounting rail;
an anti-corrosion coating created on a surface of the support profile or the other part; and
a plug inserted into the at least one opening, so that the at least one opening is closed by the plug.

2. The mounting rail as recited in claim 1 wherein the opening is in the support profile.

3. The mounting rail as recited in claim 1 wherein the plug is connected to the support profile positively and/or non-positively.

4. The mounting rail as recited in claim 1 wherein the plug is clamped into the mounting rail.

5. The mounting rail as recited in claim 1 wherein a height of the plug corresponds essentially to a length of the at least one opening and/or the at least one opening is completely closed by the plug and/or the plug is provided with anti-corrosion coating on the outside.

6. The mounting rail as recited in claim 1 wherein the plug is removable from the at least one opening by a force being applied onto the plug, and/or the anti-corrosion coating is a zinc coating.

7. The mounting rail as recited in claim 1 wherein a cross section of the support profile is essentially C-shaped and/or the mounting rail has an add-on part fastener for fastening at least one add-on part onto the mounting rail.

8. The mounting rail as recited in claim 1 wherein the add-on part fastener comprises at least one bolt and/or at least one screw.

9. The mounting rail as recited in claim 1 further comprising at least one anchor for embedding into the curable construction material, the at least one anchor being fastened to the support profile.

10. The mounting rail as recited in claim 1 wherein the support profile includes metal

11. A method for embedding a mounting rail into a curable construction material comprising the following steps:
arranging the mounting rail with a support profile at an embedding location;
installing a curable construction material into a space delineated by formwork so that the support profile is connected to the curable construction material at the embedding location;
curing the construction material;
affixing the mounting rail before installation of the curable construction material so that a fastener is inserted into at least one opening in the mounting rail, and the fastener is connected to a fixation object, the fixation object being the the formwork or another support; and
before the fastener is inserted into the at least one opening, removing a plug arranged in the at least one opening from the at least one opening.

12. The method as recited in claim 11 wherein the plug is removed from the at least one opening by a compressive force applied onto the plug by the fastener so that the plug is pushed out of the at least one opening, and the fastener is pushed into the at least one opening.

13. The method as recited in claim 11 wherein the fastener is a nail, a screw or a bolt.

14. A method for the production of a mounting rail comprising the following steps:
providing a mounting rail having a support profile;
coating the mounting rail with an anti-corrosion coating;
creating at least one opening in the mounting rail after the mounting rail has been coated with the anti-corrosion coating; and
after creating the opening, inserting a plug into the at least one opening.

15. The method as recited in claim 14 wherein the at least one opening is created in the support profile.

16. The method as recited in claim 15 wherein at least one opening is made by punching and, after a slug has been punched out of the mounting rail, the slug is inserted as the plug into the at least one opening.

17. The method as recited in claim 16 wherein a top and/or bottom of the slug has the anti-corrosion coating, so that, during the punching and/or during the insertion, part of the anti-corrosion coating of the slug transfers to a delineation rim of the mounting rail at the at least one opening.

18. A structure comprising:
a curable construction material; and
a mounting rail as recited in claim 1 embedded into the construction material.

19. A structure produced in accordance with the method as recited in claim 11.

20. A mounting rail produced in accordance with the method as recited in claim 14.
